(19) United States
(12) Patent Application Publication
(10) Pub. No.: US 2006/0015675 A1
(43) Pub. Date: Jan. 19, 2006

(54) Secure method for modifying data recorded in a memory card

(76) Inventor: Nicolas Pangaud, Valbonne (FR)

Correspondence Address: JAMES C. LYDON, 100 DAINGERFIELD ROAD, SUITE 100, ALEXANDRIA, VA, 22314, US

(21) Appl. No.: 10/534,975

(22) PCT Filed: Dec. 12, 2003
(86) PCT No.: PCT/FR03/03696

§ 371 Date: May 16, 2005

(30) Foreign Application Priority Data
Dec. 12, 2002 (FR) 0215740

(51) Int. Cl. G06F 12/00

(52) U.S. Cl. 711/103; 711/163

(57) ABSTRACT

Method for modifying data in a card transaction system including a smart card and a reader capable of reading the card, the card including a non-volatile, erasable and rewritable memory having at least one location to record a data value relating to card transactions. Each transaction results in modification of the data value, the latter being a monotonic function in time. At each transaction, a data value writing operation performs the writing of the new data value (Y) in a first location (B) of two predefined locations in the memory forming a counter, the writing operation erasing the old data value recorded in the second location (A) such that, at the end of the correctly performed writing operation, the first location contains the new data value whilst the second location contains the value zero.

### TECHNICAL FIELD

The present invention relates to the systems in which part of the data records stored in a smart card is modified when a transaction is performed with a card reader and relates more particularly to a secure method for modifying data recorded in a smart card during a transaction with a reader.

### BACKGROUND ART

Smart cards also called chip cards are increasingly used as a carrier for data associated with the cardholders. These cards include contactless cards, for which the exchange of information is carried out by contactless electromagnetic coupling between an antenna housed in the card and an associated reader, which have been developed as access cards to controlled access zones, or as electronic purses.

In general, smart cards use non-volatile, erasable and rewritable EEPROM or flash EPROM-type memories, such that the data remains written in the memory even when the latter is switched off. They further allow updating of recorded data by erasing one or several memory locations and writing new data.

It is possible that, during a transaction, the memory is corrupted due to an accidental interruption of the power supply generally due to an “abrupt withdrawal” of the card, i.e. the removal thereof before the processing operation has ended, which results in the loss of earlier data without new data being recorded. This risk is particularly great with contactless-type cards where the spatial limits within which the card can function correctly are not perceptible.

There is an added risk in the case of non-volatile EEPROM-type memories with which, if a writing operation is interrupted before its normal end, the data may be written nonetheless, and can therefore be read correctly shortly after the writing operation. However, if this reading is repeated at a later point, it is not certain that this can be performed correctly, as the retention of information in the memory cell will have been insufficient as a result of the prematurely interrupted writing operation.

To ensure data integrity, it is therefore desirable for the cards to be protected against such risks, by ensuring that the data is either in the modified state, or in the state prior to modification, but never in an undetermined intermediate state resulting from an “abrupt withdrawal”.

For reasons of transaction security, it is essential to restart the entire transaction should a power cut occur during the course of the transaction, at the risk of irreparably losing sensitive data (for example the credit balance of an electronic purse) if it is not possible to begin again from the start of the transaction.

In response to the problem detailed above, the storing of the data record in a buffer memory before carrying out its modification has been considered. Once all the modifications have been made to the records to be modified, the old records are erased from the buffer memory.

Unfortunately, for each record, this method requires a saving operation in the buffer zone, an operation for erasing the record to be modified, a rewriting operation and an operation for erasing the old record in the buffer zone, giving a total of 4 operations. This operation has therefore the disadvantage of being time-consuming, which is a major disadvantage with contactless cards.

Furthermore, the saving of the data in another location in the memory before erasing the earlier data requires the presence of a “flag” for indicating that the modification operation has been carried out correctly or otherwise according to the flag value. The flag can be a single bit which takes the value 0 or 1 according to whether modification has taken place correctly or otherwise. Insofar as it is not conceivable for obvious reasons to record check bits at the same location as the data, the only solution consists in recording the flag (the check bit or bits) in a memory location reserved for this purpose and therefore an entire block of 16 or 32 bits when a single bit or just a few bits are sufficient.

The disadvantages mentioned above take on even more importance when the smart card is used in certain applications requiring only a low capacity memory where it becomes imperative not to waste positions in the memory and wherein the value of the data modified at each transaction is a monotonic function in time. In such applications, the memory data record is either an increasing counter which increments in time such as for example a photocopier, or a decreasing counter in the case of a card for public transport where the value of the record is decremented by one unit with every journey, or an electronic purse where the value of the record can only decrease.

### DISCLOSURE OF THE INVENTION

Thus the aim of the invention is to achieve a method for modifying data in a smart card during a transaction which is carried out in a minimum amount of time compatible with the access time to which the card is limited during the transaction.

Another aim of the invention is to achieve a method for modifying data in a smart card of the contactless type which does not require the reservation of check bits (flag) in a memory location.

The object of the invention is therefore a method for modifying the data in a card transaction system including a smart card or the like and a reader capable of reading the card when it is in a determined position in relation to the reader, the card including a non-volatile, erasable and rewritable memory comprising at least one location to record a data value relating to the transactions performed by the card, each transaction resulting in the modification of the data value, the latter being a monotonic function in time. At each transaction, a data value writing operation performs the writing of the new data value in a first location of two predefined locations forming a counter in the memory, the writing operation performing the erasing of the old data value recorded in the second location such that, at the end of the correctly performed writing operation, the first location contains the new data value whereas the second location contains the value zero.

### BRIEF DESCRIPTION OF THE DRAWINGS

The aims, objectives and characteristics of the invention will become more clearly apparent on reading the following description with reference to the drawings in which:

FIG. 1 is a schematic representation of the memory of a smart card in which the method according to the invention is implemented,

FIG. 2 is a schematic representation of the content of the two-tier counter of the memory for each phase of the writing operation,

FIG. 3 is a schematic representation of the two-tier counter of the smart card for each phase of the rewriting operation in a first situation after abrupt withdrawal,

FIG. 4 is a schematic representation of the two-tier counter of the smart card for each phase of the rewriting operation in a second situation after abrupt withdrawal,

FIG. 5 is a schematic representation of the two-tier counter of the smart card for each phase of the rewriting operation in a third situation after abrupt withdrawal,

FIG. 6 is a schematic representation of the two-tier counter of the smart card for each phase of the rewriting operation in a fourth situation after abrupt withdrawal, and

FIG. 7 is a schematic representation of the two-tier counter of the smart card for each phase of the rewriting operation in a fifth situation after abrupt withdrawal.

### DETAILED DESCRIPTION OF THE INVENTION

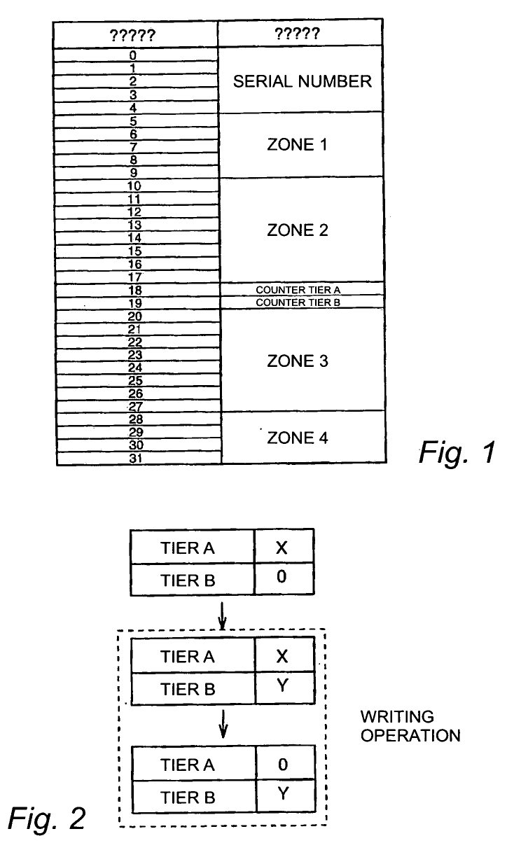

In a chip card of the type with a wired logic memory used in applications requiring a little amount of memory, the memory locations are limited. Thus, the memory of a chip card such as illustrated in FIG. 1 is an EEPROM-type memory having a capacity of 32 16-bit words. The invention described below allows for the omission of a check zone in the memory requiring the reservation of an entire word. For this, two memory locations forming a two-tier counter (tier A, tier B) are reserved at the recording of the new data value at each transaction carried out between the reader and the smart card.

The principles of the invention are advantageously used in all of the applications where the data value modified at each transaction is a monotonic function in time. In some cases (for example a card used to make photocopies), the recorded value is incremented while in other applications such as access to controlled access zones or the electronic purse, the data value decreases. However, it is preferable to increment rather than decrement the counter. As a matter of fact, when there is an abrupt withdrawal, the risk is that there is not a correct retention of the bits which have been written in the memory. In this case, the recorded value can decrease because each bit 1 can switch back to 0. If a decrementation is used, with the incorrectly written value decreasing, the decrease thereof constitutes a risk to the cardholder insofar as it is not possible to know if the value in the memory is the result of a normal decrementation or an abnormal decrease of the memory content. Conversely, when incrementation is used, the decrease of the memory presents no risk insofar as the value to be considered is the preceding value before incrementation when there is a decrease of the incorrectly recorded value subsequent to an abrupt withdrawal.

In the case of a decrementation, it is easy to consider each time the binary two's complement of the data value. Thus, in the following, the data value is incremented at each transaction, irrespective of the application in question.

The method according to the invention consists in recording the new data value which was the object of the modification in the tier of the counter that contained the value 0 and erasing the other tier of the counter to set its value at 0. These two phases which cannot be reversed, are triggered by an instruction to write the new value from the reader at the time of the transaction.

FIG. 2 illustrates the normal course of the operations. At the beginning, the reading of the counter makes value X appear in tier A and value 0 in tier B. The writing instruction then performs the writing of the new value Y in tier B, then the erasing of value X from tier A. Thus, the counter is incremented in one instruction.

Unfortunately, an abrupt withdrawal of the card can occur during the transaction, in particular when the chip card is a contactless card. In this case the writing operation does not proceed correctly and either the writing of the new value has not been performed correctly, or the old value has not been erased. In this case, the transaction does not succeed or is not validated. The result of this can be that the opening of a gate providing access to a controlled access zone is not authorised or that a purchase by a retail terminal in the case of an electronic purse is not permitted.

The cardholder therefore restarts the operation consisting in passing his/her card in or in front of a reader. It first performs the reading of the counter which indicates that neither of the two tiers of the counter is at the value 0. It deduces immediately therefrom that there has been an abrupt withdrawal and therefore performs the repairing of the counter as described below.

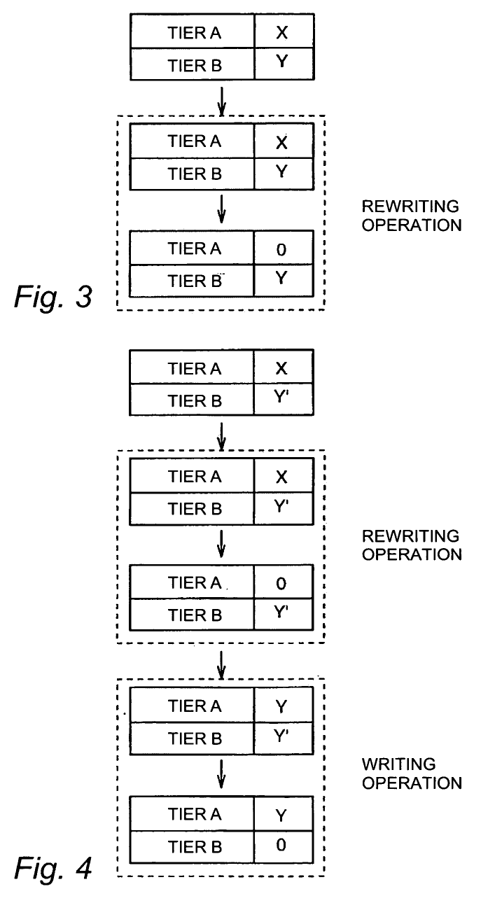

FIGS. 3 to 7 illustrate the counter repair operations when there has been an abrupt withdrawal depending on whether this abrupt withdrawal has occurred during the writing phase, between the writing and erasing phases or during the erasing phase.

In a first situation illustrated by FIG. 3, the abrupt withdrawal has taken place during the writing phase, the value Y has been written but the value X has not been erased. In this case, and although the value Y is correct, it is not possible to guarantee the retention of this value in tier B. The value Y is therefore rewritten before performing the erasing of the value X from tier A to set it at 0. It is to be noted that the writing of a memory location is an OR function between the value which is located there and the new value and that consequently, a new value can only be written if the old value is equal to 0 or identical to the new value (which is the case here).

In a second situation illustrated in FIG. 4, the abrupt withdrawal has taken place during the writing phase, a value Y′ between X and Y has been written in tier B and the value X has not been erased from tier A. In this case, a first writing operation performs the rewriting of Y′ in tier B and the erasing of X from tier A. Then, a writing operation performs the writing of Y in tier A and the erasing of Y′ from tier B, such that the counter is again in a normal situation where one tier contains the new value and the other tier is at 0.

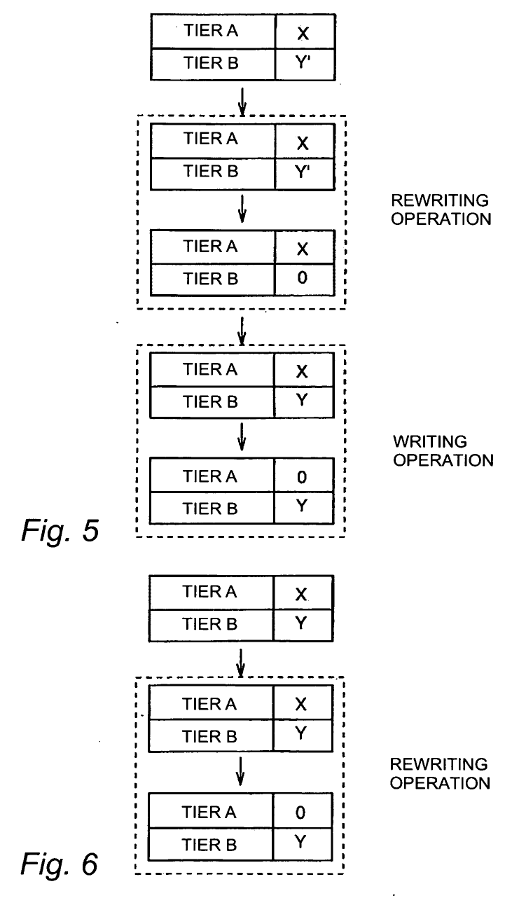

In a third situation illustrated in FIG. 5, the abrupt withdrawal has taken place during the writing phase, a value Y′ less than X has been written in tier B and the value X has not been erased. In this case, a first rewriting operation performs the rewriting of the value X in tier A and the erasing of Y′ from tier B. This is justified by the fact that the repair of the counter is always carried out with the highest value which is, in this instance, the value X. Then, a writing operation performs the writing of the value Y in tier B and the erasing of X from tier A.

In a fourth situation illustrated in FIG. 6, the abrupt withdrawal has taken place between the writing phase and the erasing phase, the value Y has been recorded in tier B but the value X has not been erased from tier A. As the retention of the value Y cannot be guaranteed, a rewriting operation performs the rewriting of the value Y in tier B and the erasing of the value X from tier A.

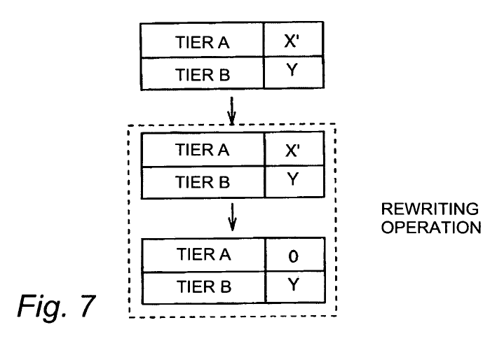

In a fifth situation illustrated in FIG. 7, the abrupt withdrawal has taken place during the erasing phase, the value Y has been written in tier B but the value X has not been correctly erased and a value X′ is found in tier A. It is therefore necessary to perform a rewriting operation of the value Y in tier B which therefore allows the erasing of the value X′ from tier A.

In all of the situations which have just been described, the repair of the counter was undertaken because neither of the two tiers contained the value 0, and after repair, one of the two tiers contains the new data value whilst the other tier contains 0. It is to be noted that in no situation is the counter again in a state where the maximum value found in tier A or tier B is less than the old value (X).

1-10. (canceled)

11. A method for modifying the data in a card transaction system including a smart card or the like and a reader capable of reading said card when it is in a determined position in relation to said reader, said card including a non-volatile, erasable and rewritable memory comprising at least one location to record a data value relating to the transactions carried out by said card, each transaction causing the incrementation of said data value;
said method comprising, at each transaction, an operation for writing said data value performs the writing of the new data value (Y) in a first location (B) which contains the value zero among two predefined locations forming a counter in said memory, said writing operation performing the erasing of the old data value (X) recorded in the second location (A) of said two locations such that, at the end of the writing operation, said first location contains said new data value whilst said second location contains the value zero if this writing operation was performed correctly, or none of the two locations in said counter contains the value zero if said writing operation has not been performed correctly as a result of an abrupt withdrawal of said card in the course of the transaction.

12. The method according to claim 11, further including a repair of said counter by a rewriting operation comprising rewriting said new value (Y) in said first location (B) and erasing said old value (X) from said second location (A) when the abrupt withdrawal has taken place during the writing phase of said new value.

13. The method according to claim 11, further including, when said first location (B) contains an incorrect value (Y′) between said old data value (X) and said new data value (Y), a repair of said counter by a rewriting operation comprising rewriting said incorrect value in said first location and erasing said old value from said second location, followed by a writing operation comprising writing said new value in said second location (A) and erasing said incorrect value from said first location.

14. The method according to claim 11, further including, when said first location (B) contains an incorrect data value (Y′) which is less than said old value (X), a repair of said counter by a rewriting operation comprising rewriting said old data value (X) in said second location (A) and erasing said incorrect data value, followed by a writing operation, comprising writing said new data value (y) in said first location and erasing said old data value from said second location.

15. The method according to claim 11, further including a repair of said counter by a rewriting operation comprising rewriting said new data value (Y) in said first location (B) and erasing said old data value (X) from said second location (A) when the abrupt withdrawal has taken place between the writing phase of said new data value and the erasing phase of said old data value.

16. The method according to claim 11, further including, when the abrupt withdrawal has taken place during the erasing phase of said old data value (X) and an incorrect data value (X′) is recorded in said second location (A), a repair of said counter by a rewriting operation comprising rewriting said new data value (Y) in said first location (B) and erasing said incorrect data value from said second location.

17. A card transaction system including a smart card or the like and a reader capable of reading said card when it is in a determined position in relation to the reader, said card including a non-volatile, erasable and rewritable memory comprising at least one location to record a data value relating to the transactions carried out by said card, each transaction causing the incrementation of said data value;
said system comprising a memory which includes a predefined first location and a predefined second location, forming a counter, each transaction resulting in a writing instruction performing the writing of a new data value (Y) in that location from said locations (B) which contains the value zero and the erasing of the old data value (X) in the other location (A), such that, at the end of the writing operation, said first location contains said new data value whilst said second location contains the value zero if this writing operation was performed correctly, or none of the two locations in said counter contains the value zero if said writing operation has not been performed correctly as a result of an abrupt withdrawal of said card in the course of the transaction.

18. The system according to claim 17, wherein said smart card is a contactless card.
